(19) United States
(12) Patent Application Publication
(10) Pub. No.: US 2018/0180125 A1
(43) Pub. Date: Jun. 28, 2018

(54) COLD SPRAY LASER COATED OF IRON/ALUMINUM BRAKE DISCS

(71) Applicants: Hyundai America Technical Center, Inc, Superior Township, MI (US); Hyundai Motor Company, Seoul (KR); Kia Motors Corporation, Seoul (KR)

(72) Inventor: Michael Hollis, Whitmore Lake, MI (US)

(21) Appl. No.: 15/390,428

(22) Filed: Dec. 23, 2016

(51) Int. Cl. F16D 66/02; F16D 65/12; C23C 24/08

(52) U.S. Cl. CPC F16D 66/02; F16D 65/127; C23C 24/087; F16D 2250/0046; F16D 2200/0021; F16D 2200/003; F16D 2200/0026; F16D 2200/0013

(57) ABSTRACT

In one aspect, a braking system is provided that comprises a part (e.g., a brake disc) with a surface that includes a metal coating applied using a cold spray laser coating. Vehicles also are provided having a part (e.g., a vehicle brake disc) with a surface that includes a metal coating that may be applied using a cold spray laser coating is provided. The part (e.g., a brake disc) has improved properties such improved resistance wear and corrosion. A metal coating may also, e.g., serve as a wear indicator for the coated part.

### BACKGROUND

### (a) Field of the Disclosure

The present disclosure relates to vehicle parts (e.g., vehicle brake discs) having improved properties such as improved resistance wear and corrosion, where the vehicle brake discs feature alloy coatings (e.g., alloy coatings applied via cold spray laser assemblies). The present disclosure also relates to a metallic coating layer that may be used as, e.g., indicators of vehicle part wear (e.g., brake rotor wear).

### (b) Description of Related Art

Vehicle parts (e.g., vehicle brake discs) are susceptible to problems such as corrosion, wear, and distortion that can impact performance of the vehicle and/or the safety of vehicle occupants. For example, corrosion on the friction surface causes noise and/or pulsation while braking. Conventional cast iron brake discs are susceptible to such corrosion issues. Further, conventional cast iron brake discs are heavy, and lighter brake discs reduce a vehicle's unsprung weight and may confer benefits such as improved handling of the vehicle. Accordingly, vehicle brake discs that have improved thermal, wear, and corrosion properties and/or which have reduced mass would be useful.

Conventional processes for coating vehicle components include conventional thermal processing (e.g., ferritic-nitro carburizing (FNC)). Immersion heat treatment of cast iron brake discs into a salt bath results in a chemically modified surface that has improved oxidation and corrosion resistance. However, this process requires heating and quenching of the entire part, which may cause thermal distortion. While this process may provide vehicle components with a coated surface, thermal distortion adversely affects dimensional stability and in-process scrap results.

No other surface treatments that have been approved for original equipment manufacturer (OEM) vehicle brake discs. While some concept and aftermarket vehicles have been shown with surfaces applied using laser hot thermal spray processes, such processes will have higher thermal and dimensional distortion due to heating and cooling of the substrate material.

Surface treatments have been described for, e.g., bicycle rotors, but the technical challenges encountered in improving properties of bicycle brakes differ significantly from the challenges encountered in improving the properties of brakes used in motor vehicles (e.g., automobiles). For example, one related art describes bicycle rotors having layers of metal for improved properties such as higher wear resistance and/or higher thermal conductivity. Exemplary layers of metal used for the bicycle rotors include aluminum, copper, or stainless steel. The thin stamped steel bicycle brake discs described in the related art, however, have low torque requirements compares to those of vehicles such as automobiles. Further, brake pressure in bicycles is limited to hand strength as there is no booster.

Additionally, bicycle brake pads consist of different friction compounds with different friction coefficients. Still further, the compressive load requirements for a bicycle are minimal when compared to that of vehicle brake discs. Bicycle brakes are also not designed for operation at high temperatures or to operate with anti-lock braking systems (ABS) or traction control systems, nor is there a need for such requirements. Lastly, bicycle brake disc surfaces are perforated in order to allow for cooling and wear debris removal, functional features which are not found in vehicle brake discs, which have uniform flat and parallel surfaces. In sum, techniques and methods used for coating bicycle rotors are not expected to be applicable to the coating of motor vehicle rotors.

Moreover, a method of the related art provides a method for creating a diffusion bond between an aluminum core and stainless steel sheets. Diffusion bonding, however, has technical challenges and limitations associated with the process. For example, the requirement of high pressure rolling in diffusion bonding limits application of this process to flat discs. By contrast, it would be useful to have a process that could be applied to materials and components (e.g., rotors) of any shape. Moreover, diffusion requires high heat and pressure, usually for a substantial time period. Time-efficient processes where high pressure is not required and where heat is directed to a minimal area of the base material would also be useful. While such improvements would be desirable, there are further challenges associated by replacement of a diffusion bonding process with an alternative process, e.g., the use of sprayed metal. For example, related art teaches that metal spraying may not result in a satisfactory product due to separation between the metal base and the spray-coated metal; specifically, the spray-coated metal may tear away in pieces and lack the integrity of, e.g., a laminated sheet prepared according to a diffusion bonding process.

Further, new coating methods may permit new indictors of vehicle part wear (e.g., brake rotor wear). For example, a fiction disk of a related art features an anti-abrasion layer and integrated wear indication: when the anti-abrasion layer wears down, an indication surface element with at least one distinguishing feature, color, or texture is revealed, signaling that the friction disk has become exposed. The brake wear indicator, however, is not integrated directly into the brake disc and lengthy post processing is required. New coating methods that result in a wear indicator that is directly integrated into the metal may offer significant efficiencies in, e.g., manufacturing processes.

The above information disclosed in this section is merely for enhancement of understanding of the background of the disclosure and therefore it may contain information that does not form the prior art that is already known in this country to a person of ordinary skill in the art.

### SUMMARY

In a preferred aspects, a part is provided, where the part has a surface comprising a metal coating, and where the metal coating may be applied via cold spray laser coating. A braking system preferably comprises the part.

In a further aspect, a motor vehicle part is provided, where the motor vehicle part has a surface comprising a metal coating, and where the metal coating may be applied via cold spray laser coating. A vehicle braking system may comprise the motor vehicle part.

In another aspect, methods are provided for using a braking system which may comprises providing a part with a surface including a metal coating, wherein the metal coating is applied using a cold spray laser coating; and using the part as a component of a braking system. The part may be a brake disc such as a vehicle brake disc.

The motor vehicle part may be any part that is susceptible to, e.g., high temperatures, corrosion, erosion, or wear. In embodiments, the motor vehicle part is a component or a part of a component of the powertrain of a motor vehicle. In embodiments, the motor vehicle part is a component or part of a component of the chassis of a motor vehicle. In embodiments, the motor vehicle part is a component of the engine, transmission, drive shaft, differential, or the final drive of a motor vehicle. In embodiments the motor vehicle part is a component of the brake, suspension, or steering system of a motor vehicle. In embodiments, the motor vehicle part may be any metal or metal-containing motor vehicle part. In embodiments, the motor vehicle part is an element of a braking system for a motor vehicle (e.g., the motor vehicle part is a brake rotor, brake drum or brake disc). In embodiments, the motor vehicle part is an element of the clutch of a motor vehicle. In embodiments, the motor vehicle part is a component or a part of a component of the engine or the transmission of a motor vehicle. In embodiments, the motor vehicle part is an element of an engine of a motor vehicle.

In embodiments, the motor vehicle part is a motor vehicle brake disc, where the brake disc has a surface comprising a metal coating, and where the metal coating may be applied via cold spray laser coating. In some exemplary embodiments, the motor vehicle brake disc may be metallic (e.g., the motor vehicle brake disc comprises iron, aluminum, stainless steel, or layered steel). As should be understood, layered steel is produced where multiple layers of metal (e.g. layers of iron alloys) are welded/manufactured together to produce the steel object. In addition, the metal coating may have a thickness from about 10 μM to about 50 μM (e.g., about 15 μM to about 30 μM). In embodiments, the metal coating may have a thickness of about 0.01 mm to about 10 mm (e.g., about 0.1 to about 1 mm, about 0.5 to about 5 mm, or about 0.1, about 0.2, about 0.3, about 0.4, about 0.5, about 0.6, about 0.7, about 0.8, about 0.9, about 1 mm, about 2 mm, about 3 mm, about 4 mm, about 5 mm, or about 6 mm).

In embodiments, there is a temperature differential between the melting temperature of a metal constituent (e.g., a metal or a metal alloy) of the motor vehicle part and a metal used in a coating layer for the motor vehicle part. In embodiments, a motor vehicle part comprises a metal constituent having a high melting temperature and a coating layer for the motor vehicle part comprises a metal constituent having a low melting temperature. In embodiments, a motor vehicle part comprises a metal constituent having a low melting temperature and a coating layer for the motor vehicle part comprises a metal constituent having a high melting temperature.

In embodiments the motor vehicle part comprises or is formed from an aluminum alloy, a magnesium alloy, or iron casting, or a combination thereof.

The metal coating may include stainless steel, an alloy comprising stainless steel, copper, an alloy comprising copper, aluminum, an alloy comprising aluminum, titanium, an alloy comprising titanium, iron, or an alloy comprising iron. In further exemplary embodiments, the metal coating may include a stainless steel alloy, a copper alloy, grey iron, a titanium alloy, an aluminum alloy, or a combination thereof (e.g., the metal coating may include at least two or at least three components selected from the group consisting of a stainless steel alloy, a copper alloy, grey iron, a titanium alloy, and an aluminum alloy).

Further, the metal coating may include a stainless steel alloy, a copper alloy, and grey iron; a titanium alloy, a copper alloy, and grey iron; a stainless steel alloy and grey iron; a titanium alloy and grey iron; a stainless steel alloy, a copper alloy, and an aluminum alloy; a titanium alloy, a copper alloy, and an aluminum alloy; a stainless steel alloy and an aluminum alloy; or a titanium alloy and an aluminum alloy. Alternatively, the metal coating may include: Stainless Steel 321 Alloy+Copper Alloy 100+Grey Iron; Titanium Ti6-4V Alloy+Copper Alloy 100+Grey Iron; Stainless Steel 321 Alloy+Grey Iron; Titanium Alloy 6Ti-4V+Grey Iron; Stainless Steel 321 Alloy+Copper Alloy 100+Aluminum Alloy A356; Titanium Ti-6Al-4V Alloy+Copper Alloy 100+Aluminum Alloy A356; Stainless Steel 321 Alloy+Aluminum Alloy A356; or Titanium Alloy 6Al-4V+Aluminum Alloy A356.

In further exemplary embodiments, the surface may include a second metal coating that is an intermediate layer between the surface of the brake disc and a first metal coating (e.g., the second metal coating is an intermediate layer comprising copper). The friction surface of the motor vehicle brake disc may include the metal coating. The motor vehicle brake disc may be aluminum, and the metal coating may include stainless steel, and optionally a second layer comprising copper. Alternatively, the motor vehicle brake disc may be iron, the metal coating may include stainless steel, and optionally a second layer comprising copper.

In embodiments, the second metal coating is used as a wear indicator of the vehicle part. In embodiments, the vehicle part is an element of the motor vehicle brake (e.g., a brake rotor). In embodiments, the second metal coating is a metallic fused coating layer comprising color pigments. In embodiments, the color pigments are blending with the metal during the spray process. In embodiments, the wear indication layer is integrated above a predetermined minimum thickness of a disk. In embodiments, the color pigment is a colored mineral pigment. In embodiments, the color pigment is titanium yellow (e.g, NiO.Sb₂O₃.20TiO₂). In embodiments, the color pigment is Egyptian blue (e.g., CaCuSi₄O₁₀ or CaOCuO(SiO₂)₄).

In another aspect, the disclosure features a process for manufacturing any of the motor vehicle parts (e.g., a motor vehicle brake disc) described herein, where the process includes: supplying metal particles to flow and accelerate through an inner passage of a nozzle and out of the nozzle via a nozzle outlet toward the substrate (e.g., a motor vehicle part such as a motor vehicle disc brake); and transmitting a laser beam through the inner passage to heat at least one of the particles and the substrate to promote coating of the substrate with the particles, and where the process provides a metal coating on a surface of the substrate (e.g., a motor vehicle part such as a motor vehicle disc brake). In embodiments, the process provides a second metal layer (e.g., a metallic fused coating layer that, e.g., may be used to indicate wear of the substrate).

As discussed, in preferred aspects, a braking system is provided, such as for slowing or stopping moving components. The braking system may be part of a vehicle (e.g. motorized, non-motorized) or a power generating system (e.g. a turbine, a wind turbine, steam turbine, water turbine, etc.) Non-motorized vehicles may include railroad and mining cars, gliding aircraft, and towed vehicles such as commercial and recreational trailers.

As referred to herein, a cold spray laser coating includes a type of thermal spraying in with a stream or particles (may be solid) is accelerated to high speeds such as by a carrier gas through a nozzle toward the substrate. The particles suitably have sufficient kinetic energy upon impact with the substrate to deform plastically and bond metallurigically and/or mechanically to the substrate to form a coating. The particles are accelerated to a critical velocity such that the coating can be created. This critical velocity can depend on the properties of the particles and the substrate (i.e., deformability, shape, size, temperature, etc.). The particles can also be heated by the carrier gas in order to make the particles more plastic to deform upon impact. The amount of heat supplied from the gas can depend on the properties of the particles and the substrate. While the particles to be applied may be heated by the carrier gas, in at least certain embodiments of a cold spray laser coating process, the particles to be applied will not be separately heated above room temperature (e.g. 25-30° C.) prior to the deposition process. In certain embodiments, coating material is applied at a temperature lower than the melting point of the applied material. In certain embodiments, particles to be coated may be applied to a substrate in the range of 100 to 1500 meters/seconds, or 300 to 1200 meters/second. In certain embodiments, solid particles to be applied to a substrate suitably may have a largest cross-section of from about 1 to 200 microns, more typically 1 to 100 micron or 1 to 50 microns. A suitable cold spray laser coating process is disclosed in US Patent Publication 2011/0300306. Another suitable cold spray laser coating process is disclosed in U.S. Pat. No. 6,356,622.

Other aspects of the invention are disclosed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a schematic diagram of a laser spray coating process, according to an exemplary embodiment of the present disclosure;

FIG. 2 is a representative embodiment of a laser used in the process, according to an exemplary embodiment of the present disclosure;

FIG. 3 shows an aluminum film deposited on aluminum sheet metal, according to an exemplary embodiment of the present disclosure;

FIG. 4 shows a photomicrograph of stress-free aluminum film deposited on sheet metal, according to an exemplary embodiment of the present disclosure;

FIG. 5 shows representative new material combinations, according to an exemplary embodiment of the present disclosure;

FIG. 6 illustrates a view of an iron brake disc having a cold spray laser coating, according to an exemplary embodiment of the present disclosure; and

FIG. 7 illustrates a view of an aluminum brake disc having a cold spray laser coating, according to an exemplary embodiment of the present disclosure.

FIG. 8 illustrates an exemplary embodiment of a process according to the present disclosure.

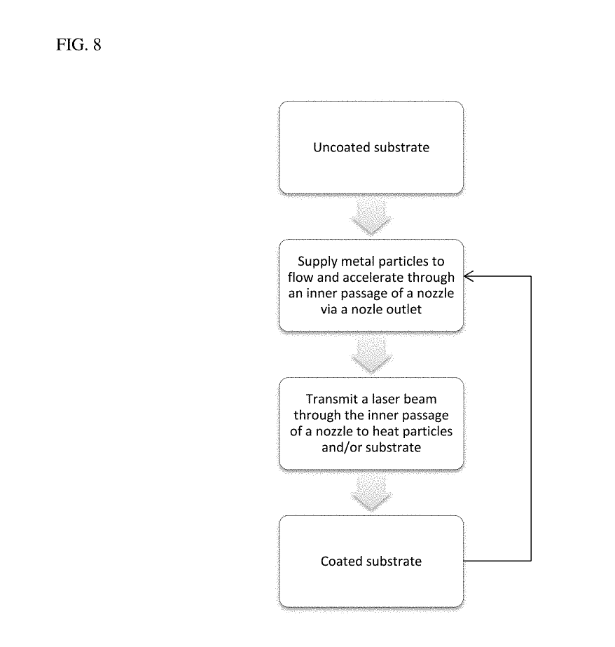

FIG. 9 shows a scanning electron microscope (SEM) crossection of a Ti₆Al₄V alloy coating on aluminum sample.

FIG. 10 shows the results of adhesive bond testing of a Ti₆Al₄V coating on aluminum 6061 at different laser assisting powers and deposition rate substrates.

FIG. 11 shows Ti₆Al₄V coated aluminum 6061 rotors.

FIG. 12 shows a SEM crossection of a stainless steel 316 alloy coating on aluminum sample.

FIG. 13 shows a stainless steel coating on an aluminum rotor.

FIG. 14 shows crossections of stainless steel coatings on grooved cast iron coupons.

FIGS. 15A-15C show stainless steel coatings on a cast iron rotor before optimization (FIG. 15A); after optimization of grooving but high deposition rate results non-even heat distribution and results in fractured coating surface (FIG. 15B); and a final result at optimized deposition conditions (FIG. 15C).

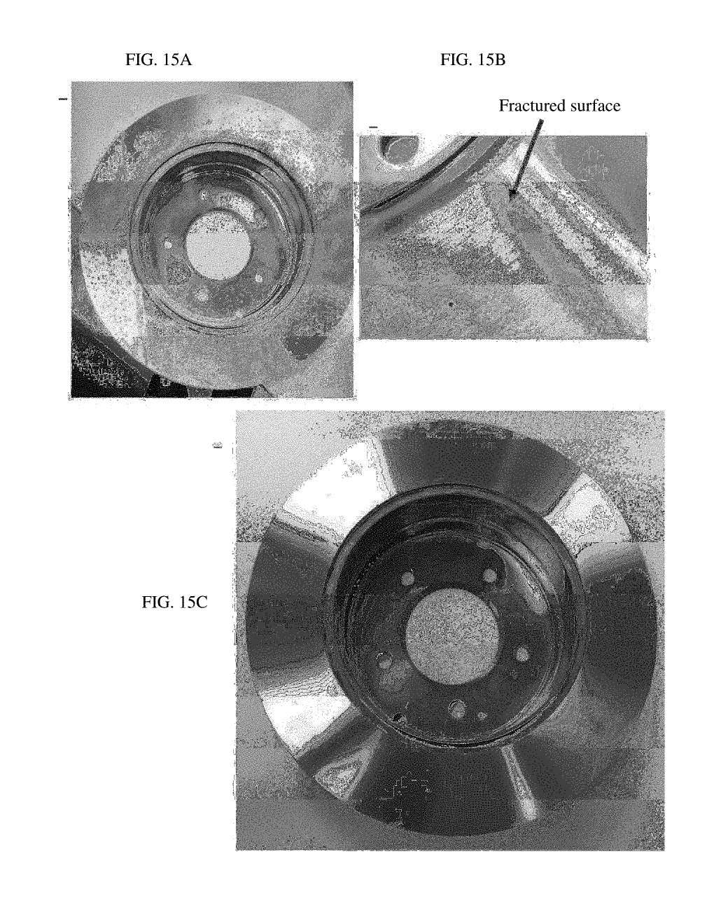

FIG. 16 shows an exemplary motor vehicle part comprising an indicator layer on an outer surface.

FIG. 17 shows an exemplary cross-section of a motor vehicle part comprising an indicator layer.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

In the following detailed description, only certain exemplary embodiments of this disclosure have been shown and described, simply by way of illustration. As those skilled in the art would realize, the described exemplary embodiments may be modified in various different ways, all without departing from the spirit or scope of this disclosure. Accordingly, the drawings and description are to be regarded as illustrative in nature and not restrictive. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, when it is described that an element is “coupled” to another element, the element may be “directly coupled” to the other element or “electrically coupled” to the other element through a third element.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, this disclosure will be described more fully with reference to the accompanying drawings, in which exemplary embodiments of the disclosure are shown.

Described herein are motor vehicle parts (e.g., motor vehicle components such as brake discs) that have alloy coatings, where the alloy coatings may be applied using a cold spray laser coating process. In exemplary embodiments, the motor vehicle components may have improved performance and longevity, and these improvements may be beneficial for vehicle handling and safety. In particular, the disclosure describes laser cold spray coating methods that may result in improved thermal, wear, and corrosion properties of the surfaces of motor vehicle parts (e.g., metal brake discs). Further, the methods described herein permit the use of new combinations of metals which were considered incompatible in the art due to, e.g., different processing requirements in, for example, conventional thermal processing methods. Additionally, a coated motor vehicle part prepared according to the methods described herein may satisfy the approved requirements (e.g., melting and/or corrosion properties) for original equipment manufacturer (OEM) motor vehicle parts (e.g., OEM vehicle brake discs).

In still further embodiments, the motor vehicle part comprise a second metal coating that may be, e.g., used to indicate wear of the motor vehicle part. The metal coating may comprise a pigment (e.g., an exemplary colored mineral pigment such as those described herein), where the addition of the pigment optionally is integrated into the same process as a cold spray process that provides, e.g., a wear resistant coating. Advantageous properties of such methods include: manufacturing efficiencies (e.g., economies of time), little or no change in the brake performance, little or no change in the wear resistance or adhesion of the resistive layer, and elimination of paint, engraving, or cutouts in order to introduce the indicator element. Still further advantages will accrue to an operator or owner of a motor vehicle comprising such parts: for example, a wear indicator such as those described herein may permit timely maintenance by the operator or owner, may prevent a vehicle part (e.g., a disc rotor) from wearing down beyond repair, and which does not require complex mechanical and/or electrical sensors).

Additional advantageous properties of the methods described herein include: requiring only localized heat, no requirement of high pressure, the ability to accommodate motor vehicle parts of different shapes and sizes without being limited to flat sheets, and allowing for the application of a single powder layer of coating. Multiple coats of different materials may be added to meet a minimum wear thickness specification or to modulate the properties of the surface coating. A coating layer provided by the methods described herein may also be functional: for example, a coating layer comprising, e.g., a pigment, may be used as a wear indicator for a motor vehicle part (e.g., a brake rotor)

In exemplary embodiments, the coated motor vehicle components may include a corrosion resistant top layer. For example, a conventional cast iron brake disc having such a corrosion resistant top layer may be manufactured in more accurate shapes faster and at lower costs than any processes presently known in the related art. In particular, the coating of a vehicle component may include an iron core, a corrosion resistant outer layer on two sides in the functional wear area, and an optional copper strike layer for heat dissipation and/or metallurgic bonding.

The brake discs may be made from iron or from non-iron metals such as aluminum. When the brake disc is made from a non-iron metal, the methods described herein may result in a non-ferrous design having less mass than the corresponding current iron parts, and such non-ferrous designs may also meet original equipment manufacturer (OEM) functional requirements.

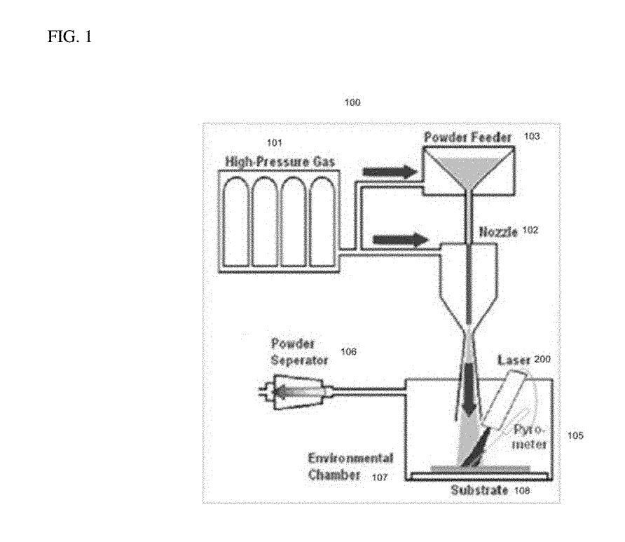

Methods known in the art may be used to apply the coatings to the vehicle components. For example, a co-axial spray laser of the related art may be used in the production process. An exemplary embodiment of the production process 100 is provided in FIG. 1. High pressure gas 101 forces the selected metal powder from the feeder 103 through a spray nozzle 102 onto the surface of the substrate 108 in a closed environmental chamber. The coaxial laser 200 tracks the spray and fuses the applied powder onto the surface of the substrate 108, heating the powder and the outermost surface layer of the substrate. The substrate may be rotated while the laser and spray nozzle are indexed using a robotic arm and a pyrometer 105 to control the surface temperature. Using a separator 106, the excess powder may be discharged out of the chamber 107 for efficient reuse. This process may be used in mass production: the laser device may be configured in a robotic cell or in a conveyorized line for high volume output. Further, a two laser cell may be used to treat both friction surfaces simultaneously for higher process efficiency.

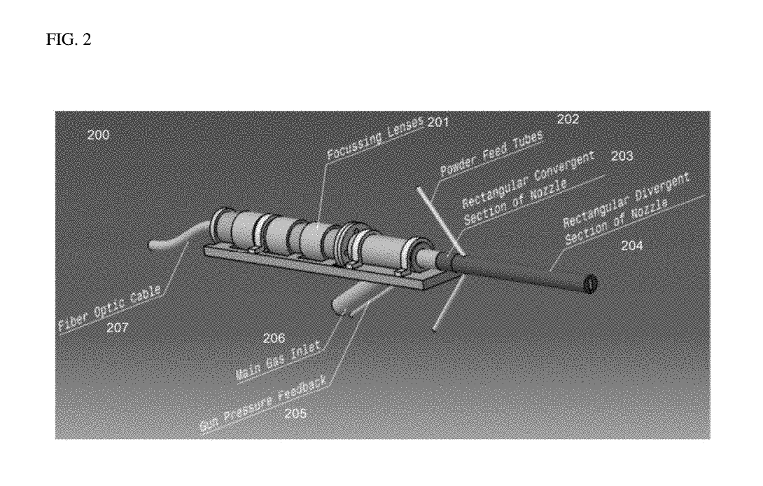

FIG. 2 illustrates an exemplary co-axial laser 200. This laser may include focusing lenses 201, powder feed tubes 202, rectangular convergent section of nozzle 203, rectangular divergent section of nozzle 204, gun pressure feedback 205, main gas inlet 206, and fiber optic cable 207.

The laser cold spray coating methods may be effective for treating the friction surfaces that result in corrosion or noise. The laser processing may be precisely controlled to a specified depth and width, which permits efficient use of the powder coating. Further, reduced corrosion and noise in the vehicle may be achieved, as well as an improved driving experience and maintaining levels of safety level maintenance.

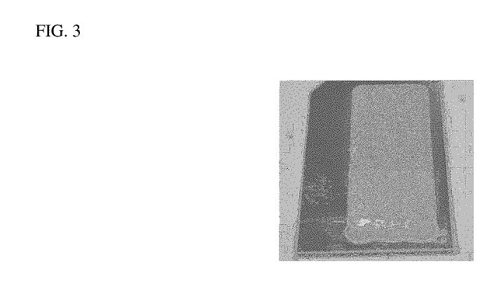

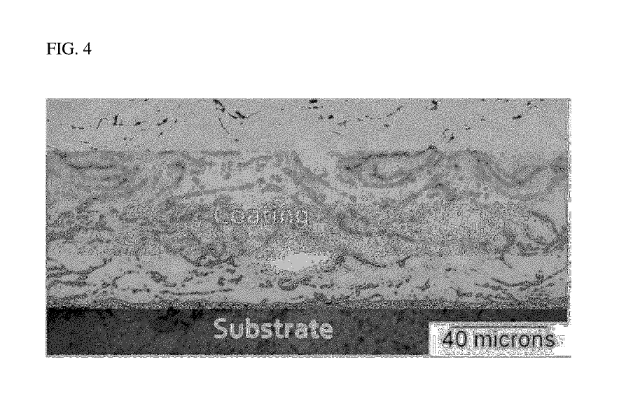

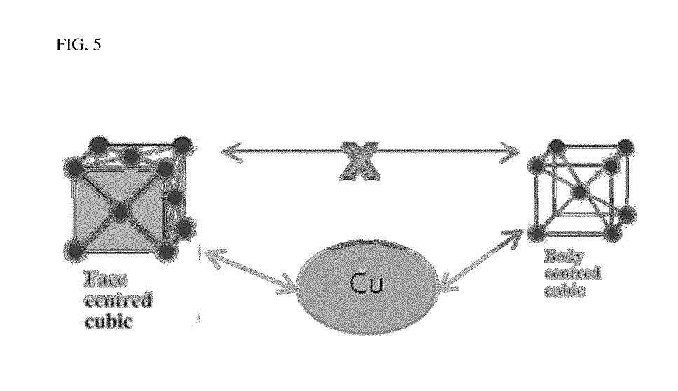

Metals used in the processes and motor vehicle components described herein feature a metallic fused coating layer compatible with a base material grain structure for complete adhesion. See, e.g., FIG. 3, which is a photograph of an aluminum film deposited on an aluminum sheet metal. A sprayed-on layer may then provide metallurgical bonding to withstand the heat and applied loads during braking and thermal cycling. See FIG. 4, which is a photomicrograph of stress-free aluminum film deposited on sheet metal. Further, an adhesion later may be applied using this process, where the adhesion layer allows the use of base and coating materials that may otherwise be incompatible (FIG. 5).

The cold spray laser coating of motor vehicle components (e.g., metal brake discs) has allowed the study and identification of new combinations of metal alloys for coatings, where the coatings show desirable properties and a combination of metal substrate and a metal coating may have been considered incompatible due to the requirements of previous methods known in the art (e.g., conventional thermal processes). In embodiments, an aluminum motor vehicle component (e.g., an aluminum rotor) may comprise a stainless steel and/or a titanium coating. In embodiments, a cast iron motor vehicle component (e.g., a cast iron rotor) may comprise a stainless steel coating. Still further exemplary combinations of materials for used in the methods and components described herein include but are not limited to:
Stainless Steel 321 Alloy+Copper Alloy 100+Grey Iron;
Titanium Ti6-4V Alloy+Copper Alloy 100+Grey Iron;
Stainless Steel 321 Alloy+Grey Iron;
Titanium Alloy 6Ti-4V+Grey Iron;
Stainless Steel 321 Alloy+Copper Alloy 100+Aluminum Alloy A356;
Titanium Ti-6Al-4V Alloy+Copper Alloy 100+Aluminum Alloy A356;
Stainless Steel 321 Alloy+Aluminum Alloy A356; and
Titanium Alloy 6Al-4V+Aluminum Alloy A356.

The processes described herein may also be modified as required in order to achieve the desired properties for the vehicle component. For example, multiple passes of alternating materials may be used to achieve the wear or thermal requirements. Further, an intermediate adhesion layer may be introduced when the lattice structure of the base coating are different. An exemplary embodiment is illustrated in FIG. 5, where use of a copper bonding layer promotes adhesion of a stainless steel (FCC lattice) onto iron (BCC lattice).

Exemplary spray parameters are described in Tables 1A and 1B.

TABLE 1A

| Coating | Feed (rpm) | Deposit | Width (mm) | Temp. (° C.) |
|---|---|---|---|---|
| Copper | 0-4 | ~20 μm | 25 max | 1020-1084 |
| Stainless Steel | 0-4 | ~20 μm | 25 max | 1230-1510 |
| Titanium | 0-6 | ~20 μm | 25 max | 1650-1670 |

TABLE 1B

| | Ti6Al4V | | Stainless 316 | | Stainless 316 | |
|---|---|---|---|---|---|---|
| | Coating on | | Coating on | | Coating on | |
| Parameter | Aluminum | | Aluminum | | Cast Iron | |
| Surface treatment | Degreased | | Degreased | | Degreased and | |
| | | | | | Grooved | |
| Laser Power | 300 | W | 200 | W | 200 | W |
| Gas Pressure | 400 | psi | 400 | psi | 400 | psi |
| Gas Temperature | 600 | deg C. | 600 | deg C. | 600 | deg C. |
| Traverse Speed | 5 | mm/s | 5 | mm/s | 5 | mm/s |
| Maximum Feed | 3 | kg/hr | 3 | kg/hr | 3 | kg/hr |
| Rate | | | | | | |
| Actual Feed Rate* | 0.3 | kg/hr | 0.3 | kg/hr | 0.3 | kg/hr |

| | | | |
|---|---|---|---|
| Coating thickness | 1 mm coating | 1 mm coating | 0.25 mm coating |

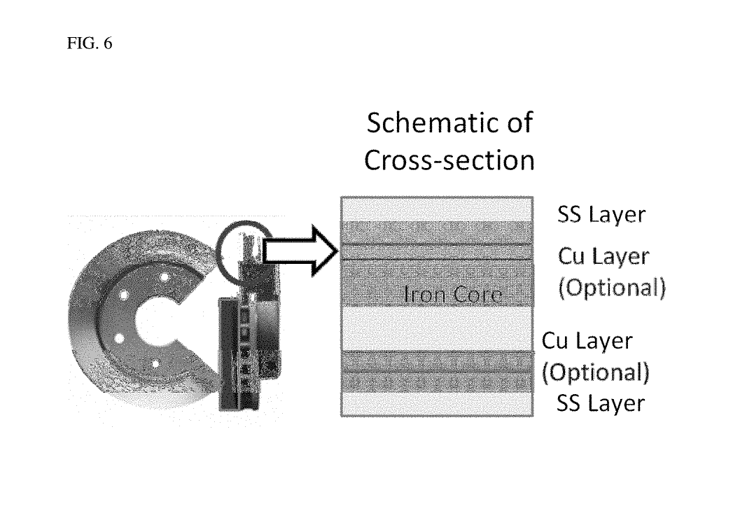

An exemplary embodiment of an iron brake disc having cold spray laser coating is provided in FIG. 6, having iron core 601, stainless steel layers 602 and 603, and optional copper layers 604 and 605. Multiple coats of material may be added to meet a minimum wear thickness specification. The thickness may include an iron core, a corrosion resistant outer layer on two sides in the functional wear area, and an optional copper strike layer for heat dissipation and/or metallurgical bonding. In certain exemplary embodiments, there is a mass neutral substitution of metal.

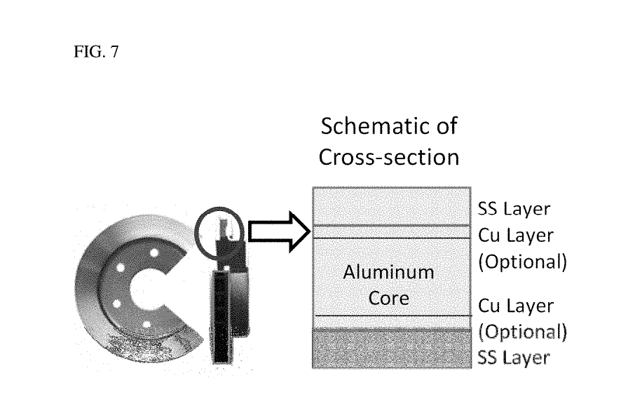

An exemplary embodiment of an aluminum brake disc having a cold spray laser coating is provided in FIG. 7, having aluminum core 701, stainless steel layers 702 and 703, and optional copper layers 704 and 705. Aluminum brake discs for light duty vehicles have not been possible to manufacture or develop due to the maximum surface temperatures that exceed the melting temperature (e.g., 660° C.) of the metal. Multiple coats of material may be added to meet the minimum wear thickness specification. The thickness may consist of an aluminum core, a corrosion resistant outer layer on two sides in the functional wear area, and an optional copper strike layer for heat dissipation and/or metallurgic bonding. Additionally, for non-ferrous brake discs, adequate thickness of a harder metal with a higher melting temperature allows tolerance of the high surface temperature and promotes diffusion of the heat through the brake disc mass.

Such exemplary aluminum brake discs may be a lighter non-ferrous design part that also meets all OEM functional requirements. In exemplary embodiments, an estimated weight reduction for four discs (e.g., 2 front discs and 2 rear discs) may be 9 kilograms, representing a 35% mass reduction from conventional cast iron brake discs. For example, the weight reduction may be about 3.0 kg per front disc and about 1.5 kg for each rear disc. The lighter discs may reduce the unsprung mass of a vehicle, which may result in an enhanced fuel economy benefit in terms of acceleration and in increased ride comfort.

Parameters that can be varied in the methods described herein include surface treatment, laser power, gas pressures, traverse speeds and deposition material feed rates.

Ti₆Al₄V Coating on Aluminum 6061 Alloy

The use of titanium alloy results in further weight reduction as opposed to steel based coating as it is a lighter material. A cross section of the coating viewed under SEM is shown in

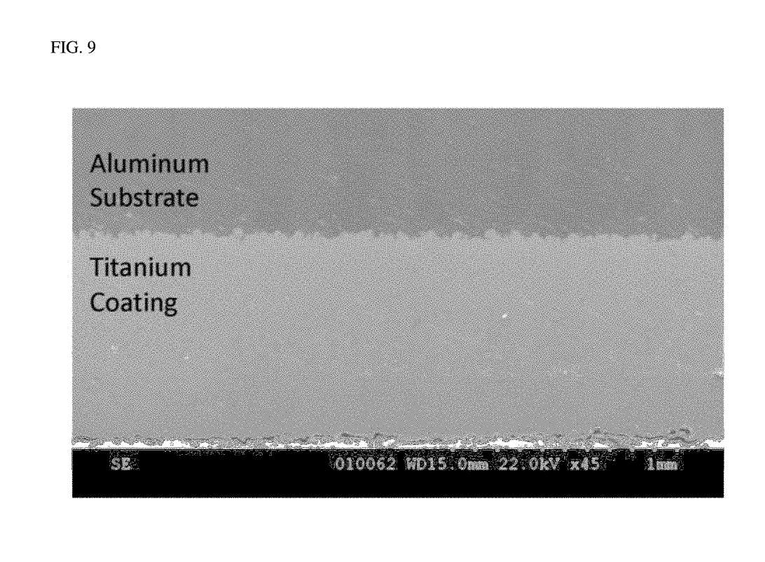

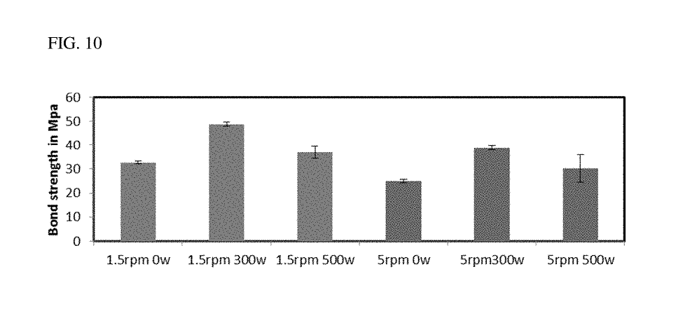

FIG. 9 which shows a dense coating and a metallurgical bond line. Bond tests were also performed on the titanium alloy coatings to optimize deposition rate and coating adhesion. The results are presented in FIG. 10 which demonstrate high bond strengths in the laser assisted process, operating at a 300 w power level; enhancing the titanium coating-aluminum substrate bond strength by 50 to 60%.

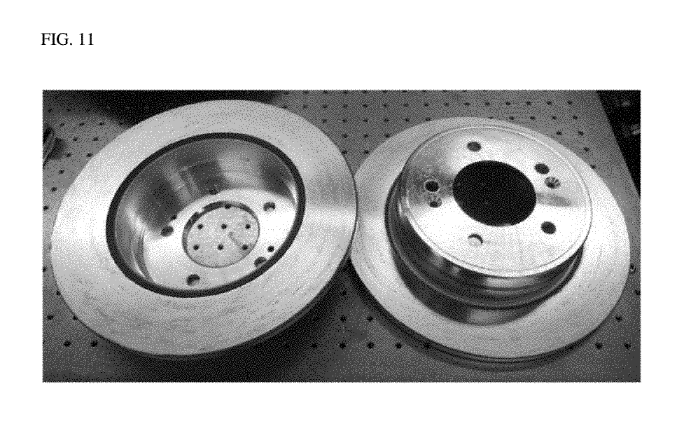

Further to the improved bond strength results, the process was able to deposit layers ranging in thickness from 1.6 to 2.15 mm. See, e.g., FIG. 11 and Table 2, which relate to the Ti₆Al₄V coated rotors and their respective thicknesses after the finishing process.

TABLE 2
Final Ti₆Al₄V Coating thickness on the Al6061 rotor

| | | | Coating thickness (mm) | |
|---|---|---|---|---|
| Sample # | Coating | Rotor | Front | Rear |
| Sample 1 | Ti6Al4V | Al6061 | 1.90 | 1.65 |
| Sample 2 | Ti6Al4V | Al6061 | 1.95 | 2.15 |

Stainless Steel Coating on Aluminum 6061 Rotors:

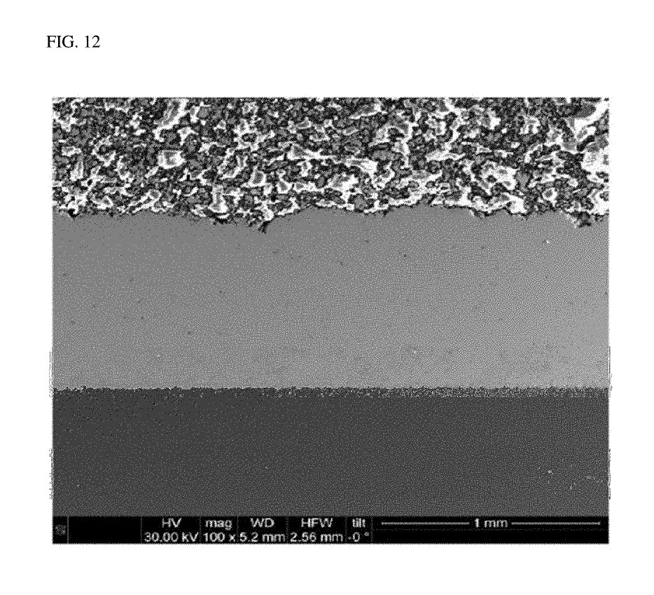

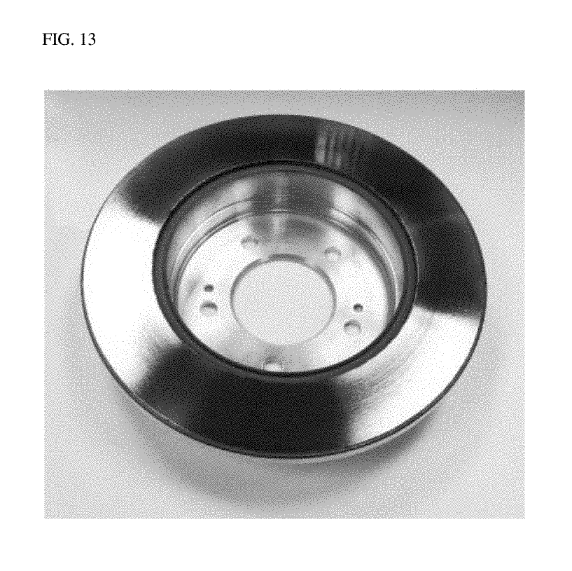

Dense and thick coatings of stainless steel were also successfully deposited onto the rotor. The density of the coating is demonstrated in the coating cross section viewed under a SEM as shown in FIG. 12. The picture of the deposition rotor is shown in FIG. 13 along with final coating thickness values of the submitted rotors in Table 3.

TABLE 3
Final SS316 Coating thickness on the Al6061 rotor

| | | | Coating thickness (mm) | |
|---|---|---|---|---|
| Sample # | Coating | Rotor | Front | Rear |
| Sample 3 | SS316 | Al6061 | 1.22 | 1.43 |
| Sample 4 | SS316 | Al6061 | 1.54 | 1.08 |

Stainless Steel 316 Coating on Grey Cast Iron Rotors

The presence of graphite on the surface of the rotor prevented formation of metallurgical bonds with the coating material. Four techniques for achieving the coating were studied:
1. Ablation with laser from the laser assisted cold spray nozzle;
2. Micro-scale erosion with stainless steel powder;
3. Ultrasonic homogenizer to break the graphite; and
4. Grooving to create anchoring sites.

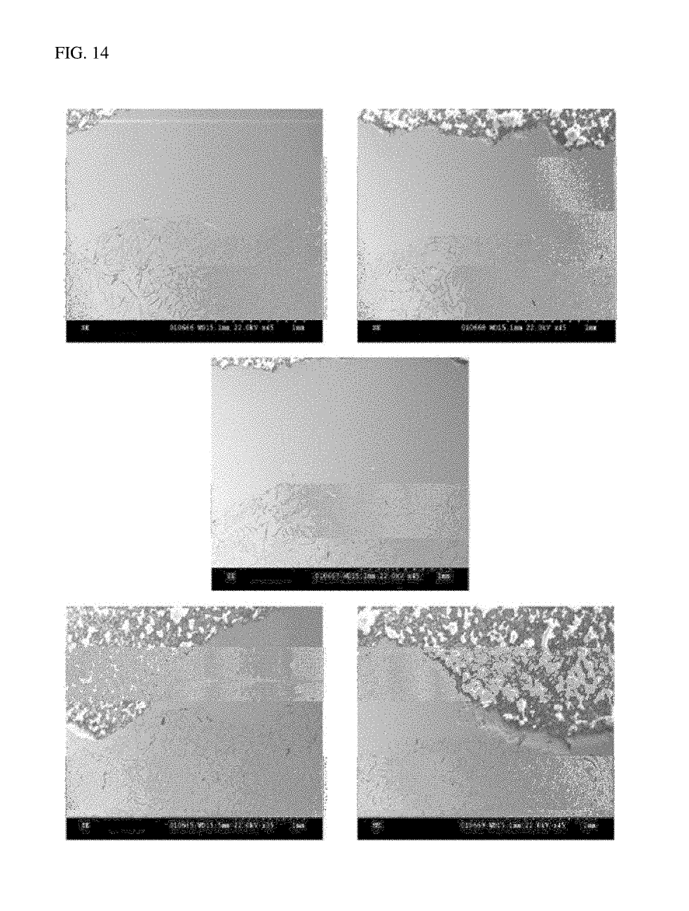

A process involving grooving the rotor's surface prior to deposition was identified as particularly effective. Without being limited by theory, one reason may be that the grooving process was able to break the graphitic network on the surface of the cast iron, resulting in greatly improved metallurgical bonding between coating and cast iron rotor. Further improvements on the technique were identified, and FIG. 14 shows the improved deposition results. The deposition parameters were optimized for grooved rotors to achieve the outcomes shown in FIG. 9C.

TABLE 4
Final SS316 Coating thickness on the Cast iron rotor

| | | | Coating thickness (mm) | |
|---|---|---|---|---|
| Sample # | Coating | Rotor | Front | Rear |
| Sample 5 | SS316 | Grey Cast-iron | .20 | 1.20 |
| Sample 6 | SS316 | Grey Cast-iron | .30 | .30 |

Overall results for the project showed positive outcomes for deposition products obtained using the processes described herein. For example, a titanium/aluminum process was able to deliver a well bonded deposition with a uniform surface finish at high deposition rates. Further, stainless steel coatings were successfully deposited to the aluminum rotors, providing a direct comparison to the Titanium coatings and as a prelude to the work of coating stainless steel onto the cast iron rotors. Lastly, stainless steel/cast iron rotors were also obtained.

A table comparing alternative methods for manufacture of brake discs is provided in Table 5.

TABLE 5

| | GM-FNC | Bicycle | | Cold Spray |
|---|---|---|---|---|
| Parameter | (Cast Iron) | Disc | Motorcycle | Laser |
| Method | Salt Bath | Mix of | Mechanical | Cold Spray |
| | | Thermal | Diffusion | Laser/Powder |
| | | and Cold | Bonding | |
| | | Spray | | |
| | | Laser | | |
| Temperature | 560° C. | — | 343-593° C. | 1380° C. |
| | (Whole part) | | (Whole part)¹ | (Localized |
| | | | | area) |
| Condition | Immersed | Flat | High Pressure, | Flexible |
| | | stamping, | Mechanically | shape, |
| | | multiple | Pre-Cleaned | multiple |
| | | layers | Parts, | alloys |
| | | | Processed in | |
| | | | Vacuum or | |
| | | | Inert Gas | |
| | | | Environment¹ | |
| Time | 20-30 Hrs. | — | “many hours” ² | 30-60 sec. |
| Minimum | 10 μm | — | 0.508 mm | Single grain |
| Layer | | | | layer (6-20 |
| Thickness | | | | μm) |

In embodiments, a motor vehicle part further comprises an optical sensor that may measure wear and provide notification of wear via an on-board vehicle diagnostic system. In embodiments, a user may take a photograph of the motor vehicle part (e.g., a brake disc). In embodiments, a user may use a mobile application to perform diagnostics. In embodiments, a motor vehicle part comprises multiple layers (e.g., multiple layers each having a distinct color) that may indicate various stages of wear. In embodiments, a wear indictor layer is an outer layer of a motor vehicle part (e.g., a brake disc).

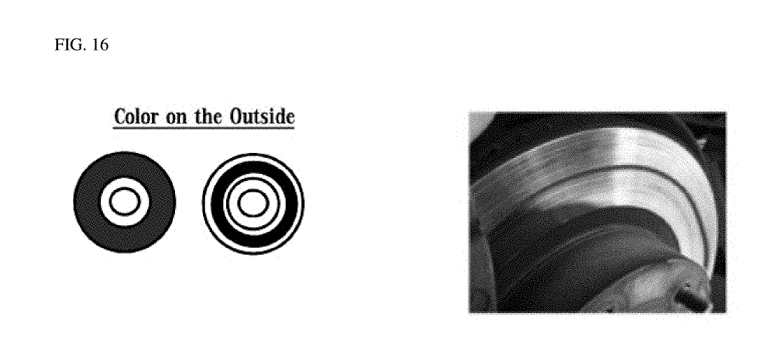

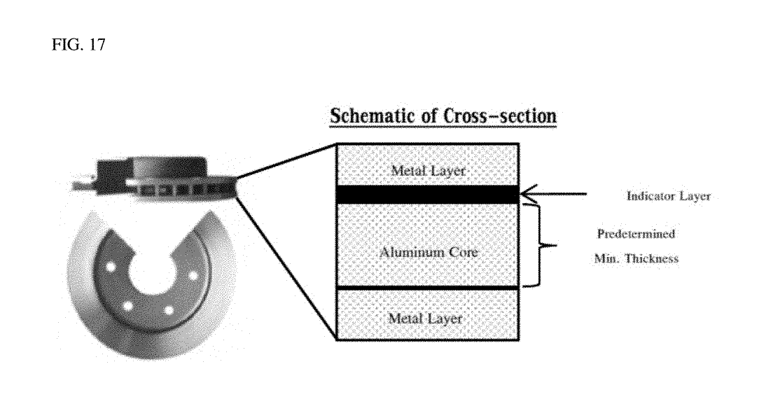

An exemplary embodiment of a motor vehicle part comprising a wear indicator is provided in FIG. 16, which is an illustration of a motor vehicle brake disc having a wear indicator layer on the outer layer of the disc. An exemplary cross-section of a vehicle part comprising an indicator layer is provided in FIG. 17, which illustrates an embodiment having an aluminum metal core with a predetermined minimum thickness. One side of the aluminum metal core features a single metal layer. The other side of the aluminum metal core features two layers: an inner indicator layer and an outer metal layer.

In sum, the vehicle components described herein may have improved performance and longevity, and these improvements may be beneficial for vehicle handling and safety. In an exemplary embodiment, a vehicle brake disc having a surface that is coated using a laser cold spray coating method may have improved thermal, wear, and corrosion properties.

The foregoing description has been directed to exemplary embodiments of the present disclosure. It will be apparent; however, that other variations and modifications may be made to the described embodiments, with the attainment of some or all of their advantages. Accordingly, this description is to be taken only by way of example and not to otherwise limit the scope of the embodiments described herein. Therefore, it is the object of the appended claims to cover all such variations and modifications as come within the spirit and scope of the embodiments herein.

What is claimed is:

1. A braking system, comprising
a part with a surface including a metal coating,
wherein the metal coating is applied using a cold spray laser coating.

2. The braking system of claim 1, wherein the part is a brake disc.

3. The braking system of claim 2, wherein the brake disc comprises iron.

4. The braking system of claim 3, wherein the brake disc comprises aluminum, stainless steel or layered steel.

5. The braking system of claim 1, wherein the metal coating has a thickness of from about 10 μM to about 50 μM.

6. The braking system of claim 5, wherein the metal coating has a thickness of from about 15 μM to about 30 μM.

7. The braking system of claim 1, wherein the metal coating comprises at least one selected from the group consisting of: stainless steel, an alloy comprising stainless steel, copper, an alloy comprising copper, aluminum, an alloy comprising aluminum, titanium, an alloy comprising titanium, iron, an alloy comprising iron, grey iron, or a combination thereof.

8. The braking system of claim 1, wherein the metal coating comprises a combination of components selected from the group consisting of:
a stainless steel alloy, a copper alloy, and grey iron;
a titanium alloy, a copper alloy, and grey iron;
a stainless steel alloy and grey iron;
a titanium alloy and grey iron;
a stainless steel alloy, a copper alloy, and an aluminum alloy;
a titanium alloy, a copper alloy, and an aluminum alloy;
a stainless steel alloy and an aluminum alloy; and
a titanium alloy and an aluminum alloy.

9. The braking system of claim 1, wherein the metal coating comprises a combination of components selected from the group consisting of:
Stainless Steel 321 Alloy+Copper Alloy 100+Grey Iron;
Titanium Ti6-4V Alloy+Copper Alloy 100+Grey Iron;
Stainless Steel 321 Alloy+Grey Iron;
Titanium Alloy 6Ti-4V+Grey Iron;
Stainless Steel 321 Alloy+Copper Alloy 100+Aluminum Alloy A356;
Titanium Ti-6Al-4V Alloy+Copper Alloy 100+Aluminum Alloy A356;
Stainless Steel 321 Alloy+Aluminum Alloy A356; and
Titanium Alloy 6Al-4V+Aluminum Alloy A356.

10. The braking system of claim 1, wherein the surface of the part includes a second metal coating that is an intermediate layer between the surface of the vehicle part and a first metal coating.

11. The braking system of claim 1, wherein the surface of the vehicle part includes a second metal coating that is an outer layer on the surface of a first metal coating on the vehicle part.

12. The braking system of claim 10, wherein the part is a brake disc.

13. The braking system of claim 12, wherein the second metal coating comprises a pigment.

14. The braking system of claim 13, wherein the second metal coating is a wear indicator.

15. The braking system of claim 13, wherein the second metal coating is an intermediate layer comprising copper.

16. The braking system of claim 2, wherein a friction surface of the brake disc comprises the metal coating.

17. The braking system of claim 2, wherein the brake disc is aluminum, the metal coating includes stainless steel, and optionally a second layer including copper.

18. The vehicle of claim 2, wherein the vehicle brake disc is iron, the metal coating includes stainless steel, and optionally a second layer including copper.

19. A method for using a braking system, comprising
providing a part with a surface including a metal coating, wherein the metal coating is applied using a cold spray laser coating; and
using the part as a component of a braking system.

20. A process for manufacturing a part comprising:
supplying metal particles to flow and accelerate through an inner passage of a nozzle and out of the nozzle via a nozzle outlet toward a substrate; and
transmitting a laser beam through the inner passage to heat at least one of the particles and the substrate to promote coating of the substrate with the particles,
wherein the process provides a metal coating on a surface of the part.

21. The process of claim 20, wherein the part is a brake disc.
